(19) United States
(12) Patent Application Publication
(10) Pub. No.: US 2026/0087554 A1
(43) Pub. Date: Mar. 26, 2026

(54) METHOD AND SYSTEM FOR MULTI-GENERATIONAL SAVINGS INSTRUMENT

(71) Applicants: Nahum ESHEL, Ramat Gan (IL); Josef ESHEL, Ramat Gan (IL); Odelia ELKABETS, Tel Aviv (IL)

(72) Inventors: Nahum ESHEL, Ramat Gan (IL); Josef ESHEL, Ramat Gan (IL); Odelia ELKABETS, Tel Aviv (IL)

(21) Appl. No.: 19/111,332

(22) PCT Filed: Mar. 14, 2024
(86) PCT No.: PCT/IB2024/052497

§ 371 Date: Mar. 13, 2025

Related U.S. Application Data
(60) Provisional application No. 63/451,974, filed on Mar. 14, 2023.

(51) Int. Cl. G06Q 40/06; G06Q 40/02

(52) U.S. Cl. CPC G06Q 40/062; G06Q 40/0225

(57) ABSTRACT

A non-transitory computer readable medium storing computer-executable instructions that, when executed by a processor, cause a machine learning (ML) engine and/or Artificial Intelligence (AI) to: train a machine learning model of the machine learning engine using financial datasets; providing parameter values to a Savings Plan Creator via a user interface; generating, by the Savings Plan Creator, a savings plan for a short or a long-term savings instrument based on the provided parameter values, the savings plan creator being driven by the machine learning engine that matches the provided parameter values to an existing savings plan selected from a Plans Database having existing savings plans stored therein, or that synthesizes a customized savings plan.

### RELATED APPLICATION/S

This application claims the benefit of priority under 35 USC § 119 (e) of U.S. Provisional Patent Application No. 63/451,974 filed 14 Mar. 2023, the contents of which are incorporated herein by reference in their entirety.

### FIELD OF THE INVENTION

The present invention relates to a short/long-term financial savings instrument, and more specifically, to a multi-generational AI-powered financial saving plan.

### BACKGROUND OF THE INVENTION

Most savings mechanisms are built on the ability to increase initial wealth by utilizing the principle of compound interest. The process of increasing wealth consists of three elements. (1) The initially invested sum (principal), (2) the rate of return obtainable from that investment, and (3) the duration of the investment period.

### SUMMARY OF THE INVENTION

According to the present invention there is provided a non-transitory computer readable medium storing computer-executable instructions that, when executed by a processor, cause a machine learning (ML) engine to: train a machine learning model of the machine learning engine using financial datasets; providing parameter values to a Savings Plan Creator via a user interface; generating, by the Savings Plan Creator, a savings plan for a short or a long-term savings instrument based on the provided parameter values, the savings plan creator being driven by the machine learning engine that matches the provided parameter values to an existing savings plan selected from a Plans Database having existing savings plans stored therein, or that synthesizes a customized savings plan.

According to further features the savings plan is implemented by a financial manager module that creates a savings fund. According to further features the savings plan includes a disbursement schedule which is based, at least in part, on milestones, the disbursement schedule being implemented by the financial manager module by disbursing funds to beneficiaries of the savings plan.

According to further features the milestones include a predetermined amount of relative wealth accrued; a birth or a death of a beneficiary; a predetermined number of times a value of the wealth accrued in the savings fund is doubled.

According to further features the ML engine is in communication with, and receives current financial data from, financial institutions, and wherein the ML engine is continually trained on the current financial data. According to further features the user interface is implemented on a website or application.

According to further features the savings fund is managed by the ML engine, wherein managing the savings fund includes making decisions including: where to invest, how much to invest, when to withdraw funds from investments, and combinations thereof. According to further features the disbursement schedule is managed by a virtual trustee driven by the ML engine.

According to further features the milestones are met based on evidence submitted via the user interface to an Evidence Analysis Module configured to determine if the evidence is legitimate. According to further features the Evidence Analysis Module is driven by the ML engine.

According to further features the long-term savings indicates that the savings fund will continue to generate wealth and effect disbursement of dividends after a biological death of an initiator of the savings plan.

According to further features the short-term savings indicates that the savings fund will generate wealth and effect disbursement of dividends at least during a lifetime of an initiator of the savings plan.

### BRIEF DESCRIPTION OF THE DRAWINGS

Various embodiments are herein described, by way of example only, with reference to the accompanying drawings, wherein:

FIG. 1 is a flow diagram 100 of the instant method;

FIG. 2 is a high-level diagram of specific components of the instant system;

FIG. 3 is a pictorial flow diagram 300 indicating the high-level components and aspects of the present system and method;

FIGS. 4, 5, and 6 are graphs which describe the development of savings value over a 150-year savings period, given various interest rates of 5%, 7%, and 10%.

### DESCRIPTION OF THE PREFERRED EMBODIMENTS

### Overview

The principles and operation of method and system for multi-generational savings apparatus according to the present invention may be better understood with reference to the drawings and the accompanying description.

A multi-generational savings instrument or apparatus is a system and method that provides and implements a savings plan that is multi-generational, i.e., earns funds exponentially over generations while paying out earnings/dividends to beneficiaries of the savings plan, usually members of a family.

The method, system, and/or product disclosed herein are intended to provide customers worldwide with a product/system for continuous, rolling and/or daisy chained financial savings which is designed for short, medium and/or long periods of time with interest and/or returns that change and increase as time passes, according to the predefined/preselected savings plan.

Investment, pension, and savings funds are limited in time, e.g., until the client retires, or until death. The present invention provides a manner of creating a system with the continuity of savings and the accumulation of returns which provides continuity from father to son, and from son to grandson and on and on.

Generally, a savings fund or pension cannot be continued and/or transferred and maintained from one generation to another generation (passing from father to son, etc.). The present system and method provide a multi-generational savings fund. Financial instruments for savings funds, and/or pensions, do not currently carry out selective personal characterization and/or does not know how to calculate and give investment recommendations for savings for a client/user, in an individual and personal way, online. By contrast, the instant method and technological system are based on dedicated software and a personal user interface, integrated software and a central AI-based system that interactively monitors the entire history, present and future financial/business potential of the customer/user and knows how to provide immediate and online optimization to the user.

The product/system enables automatic activity and optimization and/or accessibility and the possibility for the customer to log in and make changes and/or corrections. Furthermore, the method and system replace the human “trustee” with a virtual trustee, which will be powered by ML/Artificial Intelligence, and empowered to provide a radical and dramatic change for many people and/or processes in the world.

### Exemplary Embodiments

There is herein provided a financial product which is based on financial savings and/or pension for the customer's use in his lifetime and/or for the use of a generation or more after him in the future; a dedicated and unique accounting method and system; personal and dedicated software; and an interactive AI system that performs optimal analysis for the customer at any given moment.

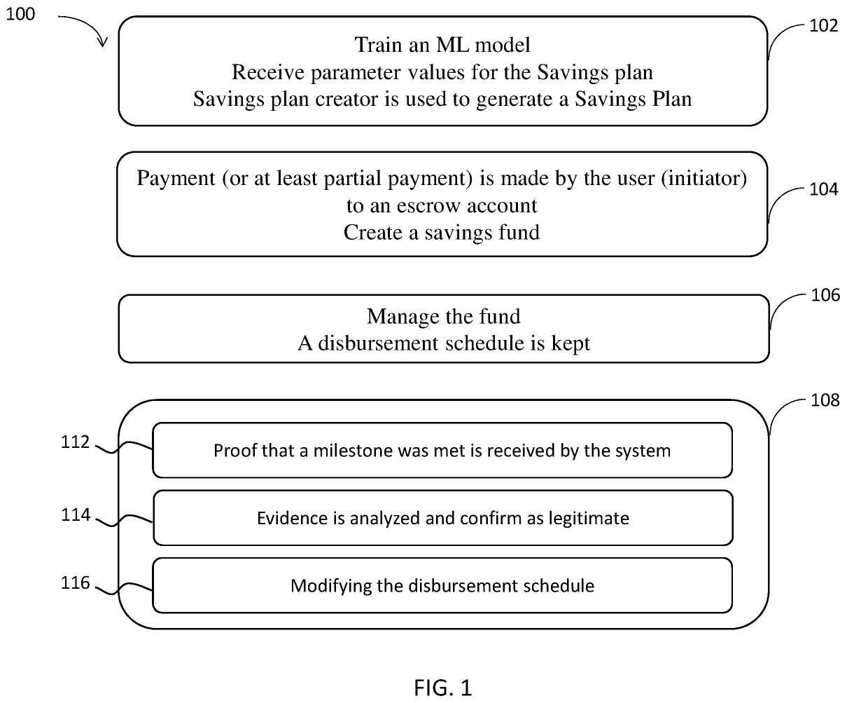

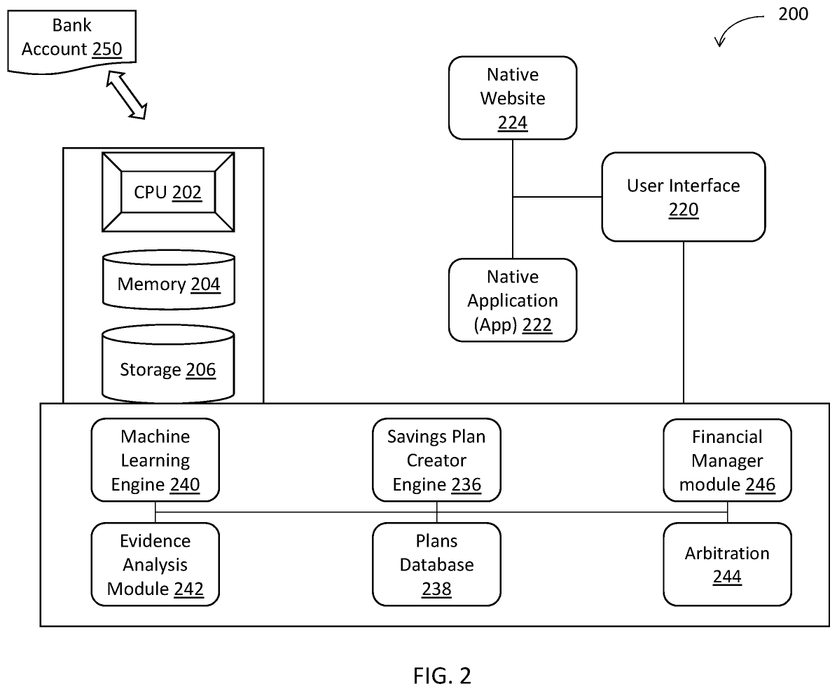

FIG. 1 illustrates a flow diagram 100 of the instant method. FIG. 2 illustrates a high-level diagram of specific components germane to the instant system 200.

An app is a software application typically installed or loaded on a mobile device such as a smartphone or tablet, but also potentially used on other computing systems such as laptops and desktop computers. A dedicated or system-native app 222 (and the same is true for a dedicated website 224, such that the following description applies equally to both user interface environments) is an app (or website) that is integrally linked to the instant system 200. The dedicated app corresponds to the dedicated website and generally provides the same functionality, as is well known in the art.

In some example embodiments, whether using a native or non-native website/app, the initiator may be invited to create the fund using the instant system website/app. The website or application requests the necessary information with which to create the savings fund. The terms “savings plan”, “savings fund”, or simply “fund”, as well as variations thereof, are used interchangeably herein. Typically, the fund is initiated with an initial sum of money and various parameters for the system to use as a guide over the course of the lifetime of the fund.

### Savings Plan Creation

At Step 102, a savings plan creator is activated via a user interface 220 of the system. The user interface 220 may be embodied in a graphical user interface (GUI) displayed on a computing device such as a desktop/laptop computer, a tablet, smartphone and the like. The users (the user(s) that sets up the plan is referred to as the initiator, beneficiaries of the fund also provide input to the system) interact with the user interface which is in communication with the system server (or network of servers, cloud, serverless application, etc.), usually via a network such as the Internet.

In one example embodiment, a non-transitory computer readable medium storing computer-executable instructions that, when executed by a processor, cause a machine learning (ML) engine to train a machine learning model of the machine learning engine using financial datasets. Alternatively, a pretrained model can be imported into the ML engine. In order to generate the plan, the user must provide parameter values. The Savings Plan Creator receives parameter values via a user interface. Then, the Savings Plan Creator generates a savings plan for a short or a long-term savings instrument based on the provided parameter values, the savings plan creator being driven by the machine learning engine that matches the provided parameter values to an existing savings plan selected from a Plans Database having existing savings plans stored therein, or that synthesizes a customized savings plan. (See below for additional details.)

In one example embodiment, the system includes a processing unit (e.g., CPU 202), a memory (e.g., memory 204), and storage (e.g., storage 206). The processing unit executes programs loaded into the memory from storage. The storage 206 stores programs, modules, databases, machine learning engines and the like, as detailed hereafter. A computer program product including instructions which, when the program is executed by a computer, cause the computer to carry out the methods described herein. In embodiments, the computer implemented method including causing at least one processor (e.g., CPU 202) to execute instructions stored in non-volatile/non-transient memory (e.g., storage 206) to perform the steps described herein.

It is made clear that the hardware, firmware and/or software components, the methods of storage and execution, and the digital/graphical representations thereof, are merely examples of non-limiting possibilities for implementing the instant system. I.e., the computer-implemented method can be implemented using any relevant non-transitory computer readable medium storing computer-executable instructions that configured to be executed by a processor. The components named herein and depicted in the Figures are intended to be representative of corresponding components, depending on how the particular system, in a given case, is embodied.

The basic terms/parameters of the savings plan are initially set out using the Creator. Some parameters may be changed at a later date (e.g., after a predetermined amount of time has passed and/or a predetermined amount of savings (possibly a relative term, or an absolute number) has accrued. Parameters may include, but are not limited to: the beneficiaries (i.e., by description, as these people will exist in the future, and there may or may not be beneficiaries in the present), the limits for paying out funds, the limits for funds that are to remain in the fund, mitigating factors, exceptions, milestones (e.g., if X amount of savings have accrued, a portion Y of the dividends may be used to create an endowment based on consensus of a predetermined portion of the beneficiaries), manner of dispersion/distribution of funds, etc.

The funds are held in, and distributed from, a system financial account 250. The system account 250 may be a single financial account or a plurality of accounts, sub-accounts, connected accounts, etc., in banking and other financial institutions.

The user interface 220 facilitates interaction with a savings plan creator engine 236 adapted to facilitate creation of the plan or retrieval of the plan from an existing saving plans database 238.

Each new plan is added to the plans database.

It is made clear that the plan is generally a set of guidelines by which the system makes decisions on how to invest the money, distribute the money, and maintain a consistent and preferably ever-increasing returns on investment. The decision engine is an AI based “brain trust” that is a machine learning (ML) model initially trained on a large dataset and thereafter continues to learn, gather pertinent information, synthesize financial data, and manage the fund. The brain trust makes the investment decisions and also controls the distribution of funds. In embodiments, the AI-based system is both the trustee of the money (accounts, investments, etc.) as well as the arbiter of savings plan.

A machine learning (ML) engine/model or an Artificial Intelligence (AI) is model trained on datasets, such as historical financial information, as well as data from the plans database. The AI or ML engine is adapted to create the savings fund based on data provided by the initiator. In some embodiments, the beneficiaries may also provide input into the system via the user interface (or later iterations thereof). For example, the AI/ML can draw up the initial savings plan based on the initiator filling out a questionnaire related to parameter values (existing money for investment, family details, etc.) based on prompts generated by the AI/ML engine. Funds Held in Third Party Account

In Step 104 payment (or at least partial payment) is made by the user (initiator) to an escrow account 250 associated with the system. In embodiments, the financial account is an account selected from the group including: a bank account, a cryptocurrency account, and a non-bank account. A non-bank account, as referred to herein, is any type of account that is not managed by a bank. This may be a digital wallet, a money transfer application and the like. The account may also, or alternatively, be an account in a financial institution that is not a bank (a brokerage firm, an investment firm, an insurance company, etc.). The savings plan is implemented by a financial manager module that creates a savings fund.

The savings plan includes a disbursement schedule which is based, at least in part, on milestones, the disbursement schedule is implemented by the financial manager module by disbursing funds to beneficiaries of the savings plan.

In Step 106, a “virtual manager” (e.g., financial manager module that is driven by the machine learning engine) manages the savings plan. Management of the savings fund includes investing and managing the wealth of the fund and creating and keeping a disbursement schedule. Investing includes making decisions including: where to invest, how much to invest, when to withdraw funds from investments, and combinations thereof.

The disbursement schedule is updated for each milestone that is met. In embodiments, the disbursement schedule is managed by a virtual trustee driven by the ML engine. The disbursement schedule includes predetermined payments, or payments determined based on the guidelines of the plan, and/or decisions made by the system. Disbursements are made to the beneficiaries by the system from the escrow account. The beneficiaries are determined based on the achievement of milestones (birth, death, marriage, reaching a predetermined age, and the like). The ML engine is in communication with financial institutions, and receives current financial data therefrom, and wherein the ML engine is continually trained on the current financial data.

In the savings plan/guidelines (set up in Step 102) milestones are detailed and defined (e.g., using User Interface 220), including providing details as to what the milestone is (time passing [e.g., the fund only starts paying out to the second or third generation], monies accrued [e.g., if sufficient money has accrued, then payments can begin, continue, or restart], relative thresholds met [absolute amounts are checked against cost of living etc. to determine relative—but real—value], beneficiary reaching a predetermined age, the etc.). The plan/guidelines may also include methods/parameters for providing proof that a milestone has been reached, what must be proven and how.

In embodiments, the milestones are met based on evidence submitted via the user interface to an Evidence Analysis Module configured to determine if the evidence is legitimate. For example, milestones may be the birth of a new beneficiary, marriage to a codependent (spouse), death of a beneficiary, a predetermined amount of relative wealth accrued, a predetermined number of times a value of the wealth accrued in the savings fund is doubled (see “doubling” below), etc. Pictures, documents, etc. can be uploaded to the system which analyzes the “evidence” of the milestone being met and then makes adjustments to the savings fund/disbursement schedule accordingly. In embodiments, the Evidence Analysis Module is driven by the ML engine.

In Step 108, the disbursement schedule is modified for each milestone that is met, an agreed-upon payment is forwarded to the beneficiaries from the escrow account, but only upon receipt by the system of proof that the respective milestone was met and confirmation of the legitimacy of the proof. Step 108 can therefore be subdivided into three steps: Step 112—receipt of proof; Step 114—analysis of proof; and Step 116—modifying the disbursement schedule. The term Disbursement Schedule is used herein to refer to the amount of funds disbursed to the number of beneficiaries. Both the amount of money as well as the number of beneficiaries is susceptible to change when a new milestone is met.

In some embodiments, the user interface 220 may include sequence of menus and/or pages that the customer and/or provider navigate in order to set up the agreement. A plan Creator Engine 236 is used to create a savings plan. In embodiments, the Plan Creator Engine 236 includes various tools, lists, examples, etc. which the users can use to create a plan which details, for example, the milestones, the evidence, and the [preferred] dispersion schedule, etc. A Plans Database 238 is a database including predefined plans that users can select from, instead of creating a new plan from scratch. In embodiments, existing plans can be modified using the Plan Creator Engine 236. In embodiments, plans/guidelines created by users are added to the Plans Database 238. As mentioned, the AI/ML predictive and/or statistical models can generate the plans based on parameter input by the buyer and/or seller.

A machine learning (ML) engine 240 uses the plans and even the inputs to the plan creator engine as inputs for the ML engine 240. The ML engine can employ any known artificial intelligence or machine learning model in the art. Alternatively, or additionally, a new model is trained or an existing model or models is/are improved upon. In embodiments, the models are pretrained on datasets of financial data, as well as other pertinent data (e.g., data pertaining to the other parameters such as the evidence, arbitration data, etc.). Financial data includes a large array of information. However, in preferred embodiments, the financial data includes investment strategies, historical information of investments/savings (e.g., strategies that worked, how they worked, why they worked, patterns of investments and/or contributing factors to the success or failure of investments, savings strategies, high-risk high yield, low-risk low yield, etc.).

The AI and ML models may be pretrained and continuously trained on all datasets relating to the system such that the system can become autonomous with little or no input from human operators and administrators. Training ML models is aimed at providing a vehicle that will recognize patterns that lead to increased revenue over time and patterns that lead to loss (which should be avoided).

In embodiments, the ML engine 240 is used to enhance the Evidence Analysis Module 242. In some embodiments, the Evidence Analysis Module 242 is autonomously operated by a machine learning (ML) engine that employs artificial intelligence (AI) or ML models to verify the evidence (e.g., birth certificates, death h certificates, marriage licenses, court decisions/determination of competence/incompetence etc.). Evidence Analysis Module 242 is configured to receive pieces of evidence from beneficiaries as proof of reaching a milestone.

In embodiments, the system also serves as an unbiased, objective, arbiter. In cases where conflict or concern arises, one or more beneficiaries may lodge a complaint or appeal against another beneficiary or group of beneficiaries. In embodiments, an Arbitration module 244 handles the complaint and analyzes whether the complaint is justified or not. Some or all of the strategies mentioned with regards to evidence analysis can be employed here as well. In all cases, the system may refer issues to a human moderator if the automated elements are unable to reach a conclusive decision. This may be particularly relevant for evidence analysis (especially when the system is relatively new) and appeal adjudication. In embodiments, the AI or ML models employ at least one of: computer vision algorithms, prediction models, and statistical models, historical data, current law practices, etc. to analyze the evidence.

In accordance with disbursement schedule (preset and/or determined by the AI based on the guidelines/plan), a Financial Manager module 246 sub-system sends instructions to the bank to transfer money from the associated [bank, or other,] account 250 to the beneficiaries. As with other sub-systems, the Financial Manager module 246 may by autonomously operated by AI or, in some cases, forward a decision, or a task, to a human operator. Beneficiaries are, in general, recognized by the system based on milestones (birth, death, marriage, reaching an age, or achievement, etc.). The milestone needs to be met to the satisfaction of various system analysis components.

The phrase “long-term savings” is intended to indicate that the savings fund will continue to generate wealth and effect disbursement of dividends even after a biological death of an initiator of the savings plan. Hopefully for many generations.

The phrase “short-term savings” indicates that the savings plan will generate wealth and effect disbursement of dividends at least during a lifetime of an initiator of the savings plan, and possibly thereafter.

The present system includes, at least, innovative, and dedicated software, e.g., in the form of an application (app) and/or website. Further, the system includes Machine Learning (ML) and/or Artificial Intelligence (AI) components and functionality. The ML/AI components are constantly learning the interactions between various datasets of financial knowledge and other quantifiable knowledge bases and how they influence each other. Furthermore, the instant system grows in exponential knowledge by adding each new plan, condition, milestone, definition, etc. to its knowledge base. The activities of different savings funds are all known to the central system, and each new interaction and activity is collated into the general knowledge of the system and used to improve the various ML models.

That is to say that, at least, all the interactions that are taking place via the system interface are being used as input to teach the ML/AI models and improve their ability to anticipate the needs of the users. The ML/AI components are able to guide/provide suggestions to initiators and beneficiaries with regards to creation, modification, and/or definitions of plans/guidelines, milestones, evidence and the like, based on initial input (training the ML/AI models on data sets) as well as ingoing input as the system is used more. The ML/AI models become better and better at reaching conclusions and/or making predictions, as the data sets grow from new input as more and more people use the system and create savings plans, receive evidence, analyze the evidence, etc.

One of the main functions of the instant system is to hold the money/funds in escrow as a virtual trustee. To this end, in the instant example embodiment, a financial server/engine handles all the financial aspects of the transactional agreement. The funds may be money, which is wired between bank accounts, money transferred via payment applications, digital currency such as cryptocurrency, and/or any manner of transferring of funds from one party to a second party (i.e., buyer to seller). Accordingly, the financial server/engine is configured to transfer any type of funds, in any manner, as agreed upon by the parties.

A central server is the term used herein which is intended to be representative of any manner of computing arrangement that facilitates the system as described herein. Various computing configurations are well known in the art, and one of skill would know how to implement the present system using any computer arrangement or configuration known in the art. As part of the ever-evolving ML/AI “fund manager” and “virtual trustee”, in some embodiments, the system is adapted to retrieve financial information from financial institutions (banks, the Federal Reserve, stock markets, brokerage house, investment funds, stock exchanges, etc., etc.).

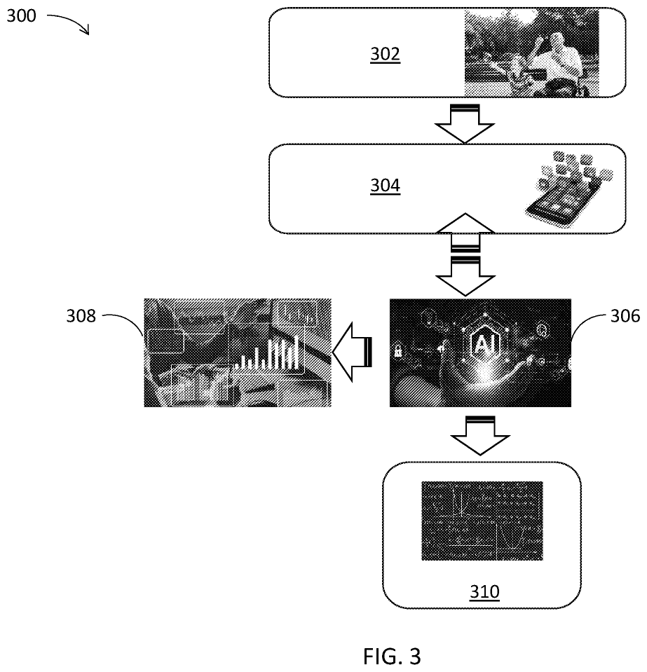

FIG. 3 is a pictorial flow diagram 300 indicating the high-level components and aspects of the present system and method. The first block, 302, indicates a potential customer, such as an initiator, or a user, such as a beneficiary of an existing savings fund. The potential customer or user interfaces with the system via the GUI of a website or application 304. The initiator/user can set up the fund by defining the parameters of the multi-generational savings instrument, or by tweaking the parameters of an existing plan (e.g., selected from the plans database 238). A beneficiary can interact with a “live” fund via the website/app, e.g., to inform the system of one or more milestones.

The heart of the system is the AI/ML model 306 embedded in the system software. The AI/ML model is initially trained on supervised datasets of, inter alia, investment planning, until the system is able to generate a plan based on basic parameters. The AI/ML model continues to learn and expand its knowledge base and improve its investment, savings, and wealth generation capabilities. The AI continues to optimize the fund plan as the knowledge grows and is refined. The knowledge may be gleaned from the fund itself (what investments succeeded, which failed, various degrees of each, etc.), from other funds that run on the same system but have different parameters, and from ongoing information from external sources.

To the latter end, in some embodiments, the system is connected to, or in communication with, banking and other financial institutions 308 locally and possibly internationally, including, but obviously not limited to, stock markets, exchanges, investment houses, central banks, pension funds, insurance companies, etc.

The AI/ML model is both trained on, and continually in communication with financial accounting knowledge bases 310. These knowledge bases include methods, approaches, and accounting systems that are known and documented. Uniquely, the knowledge base of the inventor, Nachum Eshel, is also part of the training dataset with which the AI/ML model is trained.

According to embodiments, the AI/ML model is trained on a supervised dataset and configured to generate a financial plan for a savings fund that will propagate over more than a single generation and continue to generate wealth and disburse dividends even after the biological death of the initiator or initiators.

### Example Embodiment

A family foundation that will distribute at least part of the profits from the foundation's fund as gifts to descendants. The balance will continue to generate new profits to distribute gifts to future generations as well. Although 2% has been deducted from the calculated amounts discussed below, in order to cover inflation, and despite the increase in the number of offspring (calculated according to the rate of 3 children per parent), even an average annual return of 6% is sufficient to allow the distribution of profits (not large but at least a desirable amount).

Of course, with higher returns, the profits generated in the fund are larger, and as time passes, these profits continue to grow at an increasing (exponential) rate and the gifts distributed to descendants in future generations grow and reach even more significant amounts.

It is important to emphasize that the plan is based on the principal money being given as a gift to the family fund. The profits of the fund will be paid to the descendants of the following generations (e.g., according to a power of attorney) by the “virtual trustee”. The “AI fund manager” (as discussed in detail elsewhere herein) will invest the money, and decide on a “disbursement schedule” to pay each beneficiary (or a group of beneficiaries) in subsequent generations. The payment may be a one-time sum or regular payments at intervals determined by the ML engine/financial module.

One of the important conclusions derived from the invention is the creation of a new process that utilizes the power and strength of the “time lever” (i.e., time as a lever) to create future profits on a massive scale.

Most of our savings are built on the ability to increase our wealth by utilizing the principle of compound interest. The process of increasing wealth consists of three elements. (1) The initially invested sum (principal), (2) the rate of return obtainable from that investment, and (3) the duration of the investment period. The inventor, Nachum Eshel, devoted a long time to understanding the process, the interaction between the three elements, and the relative influence and contribution of each component on the growth rate.

In Table 1 below depicts the involvement of each component in creating profits, based on the presently known, existing economic reality. The table demonstrates the profitability of an investment over several periods of time, and considering different return rates (e.g., between 4%-10%) for an initial investment of $1.

For a deeper understanding of the process, a new index has been added, termed the “doubling coefficient” (or simply “doubling”). Doubling the fund will double the result. But how will an additional 2% interest rate affect the result? Other than the simple understanding that 10% is more than 8%, and therefore a higher return will make for a higher yield-we cannot learn much from these numbers.

How can we find a parameter with which to measure the success of each return rate? Success is determined by the speed with which money grows. The faster the growth rate, the less time it would take to double the investment. In Table 1, there is an additional column that specifies the stable doubling coefficient for each return rate; and in each investment period the number of doublings that each yield/return rate can produce.

The shaded cells (right column of each time period) depict the number of times the fund doubles in worth over the specified period.

The benefit of this information is the ability to see that these doublings create a geometric series. For example: With a 4% return rate/yield, the stable doubling coefficient has been calculated by the inventor as 18 years. Meaning, it takes 18 years to double the fund. With an 8% return rate, the stable doubling coefficient calculated is 9 years.

Over a 54-year investment period the investment is doubled 3 times with a 4% return rate (3=54:18). Therefore, the first dollar doubled to $2. In the second doubling the $2 became $4, and in the third doubling the $4 grew to $8. Meaning that an investment for 54 years with a 4% return rate-grows eightfold.

With an 8% return rate the doubling coefficient is 9 years (double that of the 4% return rate), and hence over 54 years there will be 6 doublings. The meaning of six doublings is 2, 4, 8, 16, 32, 64. Meaning an investment for 54 years with an 8% return rate-grows sixty-four times. An 8% return rate is only double the 4% return rate; however, the success of the investment is 64 times, as opposed to only 8 times created at the 4% yield.

In the present economic reality, the period of investing funds is between the time one starts to generate income (which partly goes to savings), and the time when one begins to consume those savings. It is safe to assume that the duration of a standard savings period is 25-50 years.

In the present day and age, over a 50 year savings period, and given a generous 10% return rate-one could get to the best result of about 117 times the initial investment. A very decent outcome, however rare it may be.

A more common savings period would be 40 years. In the same 10% return rate we would be able to increase our fund 45 times the initial investment. This result is surprising. Shortening the investment period from 50 to 40 years reduces the profits from 117-fold to 45-fold? This roused the inventor's curiosity, and the phenomenon was given further consideration.

To better understand this extension, Table 2 is shown with longer investment periods, at 10-year intervals.

The shaded cells (right column of each time period) depict the number of times the fund doubles in worth over the specified period.

Again, we see that each 10-year extension to the investment period increases the fund in increasingly larger scales. For example: Given an 8% return rate, over 60 years—101.26 times, over 70 years—218.61 times, over 80 years—471.95 times, and over 90 years—1018.92 times. The following example shows the data as viewed from another point of view. Example: My father invested in a fund for 40 years, with an 8% return rate. He was satisfied with his success—a growth of 21.72 times his initial investment. Meaning, if he invested $10,000—his savings account reached a $217,200 fund after 40 years. If I had the same success as him, I would also reach the same amount—$217,200.

For the sake of our example, assume that my son, too, had the same investment with the same success. Now, picture an imaginary scenario—what would happen if my father decided to pass on to me his investment fund, when I began to invest myself? I would continue his investment, alongside my own, for an additional 40 years, at the end of which I passed my $217,200 to my own son.

Now, what if I opened my father's investment that was given to me, and that was allowed to grow for 80 years-what would I find? Well, instead of the $217,200 that I would find in my own fund (which I in fact passed onto my son) I would find my father's fund grew to a staggering sum of $4,719,500.

Could this truly be? I didn't increase my yield/return rate, I didn't invest more money, I simply swapped savings. Of course, the example given of passing funds from father to son is purely imaginary, but it arouses curiosity. What else can be expected if we continue to invest the fund for longer and longer periods?

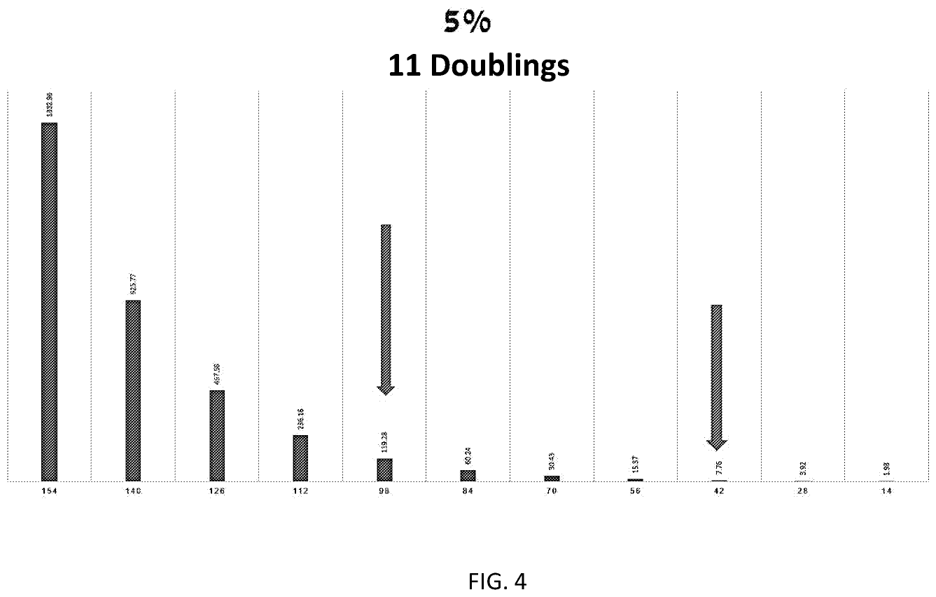

FIGS. 4, 5, and 6 depict graphs which describe the development of savings value over a 150-year savings period, given various interest rates of 5%, 7%, and 10%. After understanding the additional benefit of using the doubling coefficient in the test, the graphs were development showing the calculated value of the savings, not according to a casual division of every 5 or 10 years, but rather in a spread according to the length of the period of the doubling coefficient for the same yield.

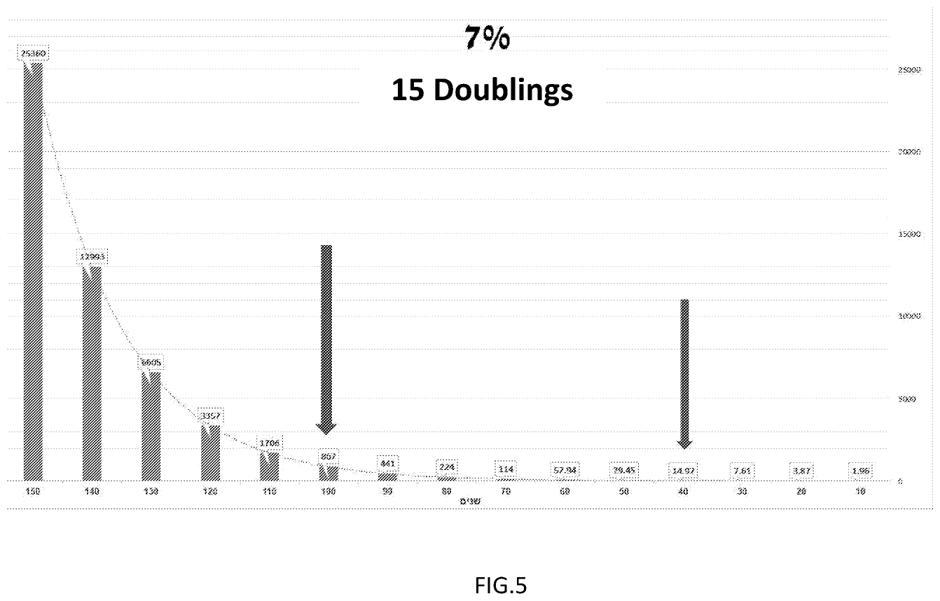

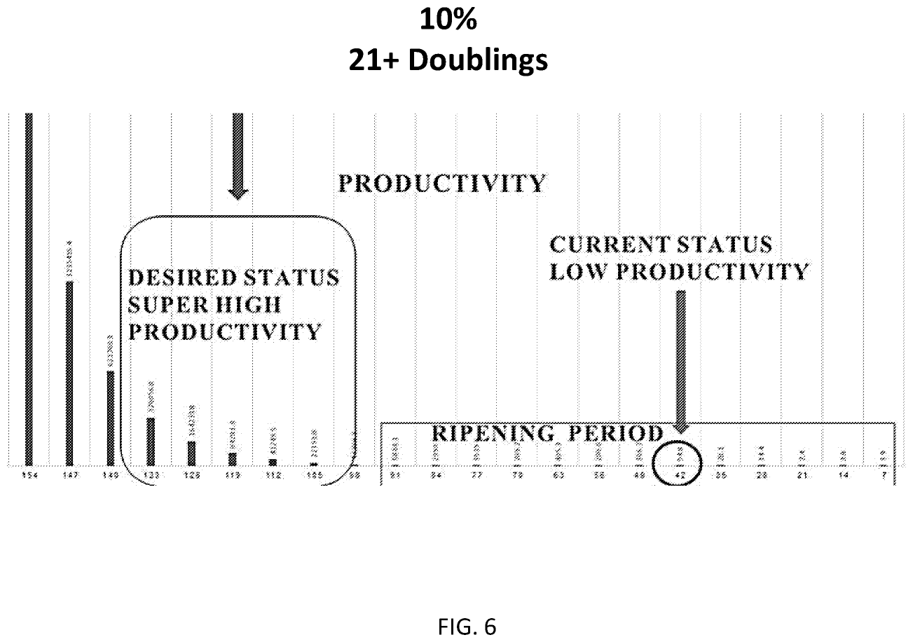

FIG. 4 depicts a graph with a 5% interest rate, with more than ten instances of the fund doubling. FIG. 5 depicts a graph with a 7% interest rate, with more than 15 instances of the fund doubling, over the same time period. FIG. 6 depicts a graph with a 10% interest rate, with more than 21 instances of the fund doubling, over the same time period.

The columns showing, on the X-axis, the size of the savings, are laid out in intervals according to the size of the doubling coefficient. So that each column will display double the height of the previous column. The picture that emerges from these graphs validates the information and meaning of extending the savings period. It also proves and reveals another fact. Looking at the shape of the curve of the graph, it seems that compared to an almost flat line at the beginning of the process, the curve line breaks and rises very sharply at some point. This break is seen in the same place in all three graphs.

The explanation for this phenomenon is in the fact that although the amount is only doubled each time, the amount being doubled keeps increasing. At the beginning of the process and up to the tenth doubling, the increase is from 1 in the first doubling to 500 in the tenth doubling, (every 10 doublings increase the savings amount by 1000 times). From the 11th doubling to the 20th doubling, the savings increase from an increment of 1,000 to an increment of 500,000. The increments in the second period (11th to 20th doublings) is so significant and noticeable, it dwarfs the previous increments, making them appear as an almost flat line in comparison.

It can be seen in the graphs that the first 10 doublings, with their low profit rates, are nothing more than the ripening period after which one can begin to see the desired profit rates. Analyzing these graphs, the inventor exposed an area of activity with abilities to increase profits beyond anything thought possible. This is, in fact, an investors paradise. An area where instead of the familiar growth of 50 times the dollar invested, one can see a growth of thousands of times, and up to 500,000-fold in the 20th doubling.

Alongside this data, there seem to be two problems. First, there are no shortcuts. To get to this wonderful area, you must first go through all the stages of the process. One cannot get to the 11th doubling without going through all previous doublings, starting with the first. This means that in the best yield, 10% return, the doubling coefficient is 7 years, meaning one would need to save for 70 years before getting to the desired area of growth. With a more moderate return rate of 7%, with a doubling coefficient of 10 years, it would take 100 years to get to the seemingly magical stage of the 11th doubling.

The second problem is therefore the length of the period. No person could live that long, and certainly not enjoy the earnings that such a plan could create. The solution seem so simple, especially seeing how, apart from the time needed, there are no conditions or restrictions or additional requirements for entry. The process is extremely simple: do not do anything, just let the fund grow without disturbing it, and the money will do all the work by itself. However, there are two problems: (1) If the person who starts the fund cannot reap its fruits, who can? (2) Who could manage the fund, keep the principal safe and disburse the profits in a diligent manner, and make sure the process works over this long period?

The proposed solution: a plan which allows one to take advantage of the time lever and answers the aforementioned questions. The problem is in the excess time required to complete the process, which is beyond one person's lifespan. Therefore, the solution is to reverse the order-instead of adding years ahead (which is impossible), the plan adds years from behind. Meaning that years are added for offspring—by saving and reinvesting funds for them, at any point in their lifetime, and even before they are born. By doing this, we allow them to optimally utilize the lever of time and allow their fund to reach its potential. According to the plan, the beneficiaries would be the offspring of the initiator, starting with the next generation. At that point, according to one example embodiment, all the descendants of the family would get, once every 40 years, a gift from the profits of the family fund. The remainder of the money in the fund continues to generate more profits to be distributed among the second generations descendants, and so on, every 40 years.

The idea is to invest for the future generation as soon as possible, even before they are born—so that the fund has the time needed to allow the money to grow, using the time lever—in order to allow a profit margin big enough to distribute among them, while continuing to reinvest the remainder for an additional 40 years, for the next generation, and so on for the generations after them.

TABLE 3
Savings from generation to generation, based on an 8% return rate.

[symbol]

| [symbol] | [symbol] | [symbol] | [symbol] | [symbol] | [symbol] | [symbol] | [symbol] | [symbol] |
|---|---|---|---|---|---|---|---|---|
| | | | | | [symbol] | | [symbol] | |
| | | | | | [symbol] | | [symbol] | |
| [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] |

[symbol]

indicates data missing or illegible when filed

There are, of course, no assurances regarding the future. One can only assume and hope.

On the one hand, there is a certain risk, as with any investment, for failure. One could possibly lose the money. On the other hand, it is possible to rely on the strength of the economy, and on the constant growth thereof. Based on the New York Stock Exchange in the last 150 years and the Tel Aviv Stock Exchange in the last 40 years-one can assume with a reasonable level of certainty that the returns in the future will be similar, or close to, those returns. Even if the market grows at lower rate-a correct use of the plan would still produce a satisfactory profit.

According to embodiments, the AI/ML model/machine learning engine 240 further drives, augments, and/or assists one or more additional aspects of the system. In a non-limiting list, the ML engine may, according to some embodiments, control or operate and work in conjunction with: the savings plan creator engine 236 (both in generating the questionnaire and in generating the savings plans, the latter being one of the main functions of the AI), the financial manager module 246 (in charge of disbursements (both with the schedule [as defined elsewhere herein] and the practical provision of instructions for transferring of monies), the arbitration module 244, the evidence analysis module 242, and even the user interface 220 itself.

Machine Learning and Artificial Intelligence cover a vast range of mechanisms, methods, and techniques. It is made clear that any type of machine learning model may be used. The term “machine learning (ML)” and grammatical variations thereof is intended to convey method of machine learning known in the art (e.g., artificial intelligence (AI), deep learning, neural networks, etc.) and/or combinations thereof. One example of a machine learning model is a neural network. The linkages in a neural network are generally pre-defined. Over some number of training examples, the strength of different relationships emerges by being reflected in the weights of each edge of the neural network as the weights of the edges are adjusted with each training example. In a neural network, an edge exists between two nodes and then over time it will develop a large or small weight reflecting a strong or weak relationship between the variables represented by the two nodes that the edge connects.

Another example embodiment of the machine learning model is a Convolution Neural Networks (CNN). The instant example is not intended to limit the method or system in any way, rather it is merely intended to portray one way of implementing the method and/or system.

Depending on what the ML model is trained for, the dataset is used to refine the model's ability to make the best decisions. It is true that market valuation and financial investment is a complex science-slash-art. However, training a model on certain aspects of the market can prove to be very successful. Also, following successful investors and investments, investment strategies that have proven themselves over time, and other proven wisdom can arm the model with many reliable tools for creating/successfully running a multi-generational savings fund.

For example, US20190378050A1 to Edkin et al. discloses a non-transitory computer readable medium storing computer-executable instructions that, when executed by a graphics processing unit, cause an ensemble of machine learning sub-engines to: train a machine learning model of the ensemble of machine learning sub-engines using a corpus, where the corpus includes a training data and a test data; classify a plurality of nodes in a graph, which includes nodes and edges and is stored in computer memory, based on the machine learning model, by setting a classification attribute of a first node and a second node of the plurality of nodes to one of a plurality of classifications; and insert an edge in the graph between the first node and the second node in response to the machine learning model detecting a pattern, where the first node corresponds to a first entity type and the second node does not correspond to a second entity type.

Other embodiments of this aspect include corresponding computer systems, apparatus, and computer programs recorded on one or more computer storage devices, each configured to perform the actions of the methods. US20190378050A1 is incorporated by reference as if fully set forth herein.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, non-transitory storage media such as a magnetic hard-disk and/or removable media, for storing instructions and/or data. Optionally, a network connection is provided as well. A display and/or a user input device such as a keyboard or mouse are optionally provided as well.

For example, any combination of one or more non-transitory computer readable (storage) medium(s) may be utilized in accordance with the above-listed embodiments of the present invention. A non-transitory computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable non-transitory storage medium may be any tangible medium that can contain or store a program for use by or in connection with an instruction execution system, apparatus, or device.

A computer readable signal medium may include a propagated data signal with computer readable program code embodied therein, for example, in baseband or as part of a carrier wave.

Such a propagated signal may take any of a variety of forms, including, but not limited to, electromagnetic, optical, or any suitable combination thereof. A computer readable signal medium may be any computer readable medium that is not a computer readable storage medium and that can communicate, propagate, or transport a program for use by or in connection with an instruction execution system, apparatus, or device.

As will be understood with reference to the paragraphs and the referenced drawings, provided above, various embodiments of computer-implemented methods are provided herein, some of which can be performed by various embodiments of apparatuses and systems described herein and some of which can be performed according to instructions stored in non-transitory computer-readable storage media described herein. Still, some embodiments of computer-implemented methods provided herein can be performed by other apparatuses or systems and can be performed according to instructions stored in computer-readable storage media other than that described herein, as will become apparent to those having skill in the art with reference to the embodiments described herein. Any reference to systems and computer-readable storage media with respect to the following computer-implemented methods is provided for explanatory purposes and is not intended to limit any of such systems and any of such non-transitory computer-readable storage media with regard to embodiments of computer-implemented methods described above. Likewise, any reference to the following computer-implemented methods with respect to systems and computer-readable storage media is provided for explanatory purposes and is not intended to limit any of such computer-implemented methods disclosed herein.

The flowcharts and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

As used herein, the singular form “a”, “an” and “the” include plural references unless the context clearly dictates otherwise.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination or as suitable in any other described embodiment of the invention. Certain features described in the context of various embodiments are not to be considered essential features of those embodiments, unless the embodiment is inoperative without those elements.

The above-described processes including portions thereof can be performed by software, hardware and combinations thereof. These processes and portions thereof can be performed by computers, computer-type devices, workstations, processors, micro-processors, other electronic searching tools and memory and other non-transitory storage-type devices associated therewith. The processes and portions thereof can also be embodied in programmable non-transitory storage media, for example, compact discs (CDs) or other discs including magnetic, optical, etc., readable by a machine or the like, or other computer usable storage media, including magnetic, optical, or semiconductor storage, or other source of electronic signals.

The processes (methods) and systems, including components thereof, herein have been described with exemplary reference to specific hardware and software. The processes (methods) have been described as exemplary, whereby specific steps and their order can be omitted and/or changed by persons of ordinary skill in the art to reduce these embodiments to practice without undue experimentation. The processes (methods) and systems have been described in a manner sufficient to enable persons of ordinary skill in the art to readily adapt other hardware and software as may be needed to reduce any of the embodiments to practice without undue experimentation and using conventional techniques.

Machine learning (ML) is a branch of artificial intelligence (AI) that leverages data to improve computer performance by giving machines the ability to “learn”.

Machine learning algorithms build a model based on sample data, known as training data, in order to make predictions or decisions without being explicitly programmed to do so. Machine learning algorithms are used in a wide variety of applications, such as in medicine, email filtering, speech recognition, agriculture, and computer vision, where it is difficult or unfeasible to develop conventional algorithms to perform the needed tasks. As used herein, the ML algorithms are employed, for example, for creating or assisting in the creation of contracts. ML algorithms are also employed, for example, as part of the Evidence Analysis Module or subsystem that analyzes the evidence that is provided as proof that a milestone has been met or a proof that a milestone has not been met, or not been met to a satisfactory degree. For example, ML algorithms for computer vision can be employed to analyze uploaded images that are intended to show before and after images of a task. The models may be trained on images of products so as to be able to recognize given features in an image.

A subset of machine learning is closely related to computational statistics, which focuses on making predictions using computers, but not all machine learning is statistical learning. The study of mathematical optimization delivers methods, theory and application domains to the field of machine learning. Data mining is a related field of study, focusing on exploratory data analysis through unsupervised learning.

Some implementations of machine learning use data and artificial neural networks in a way that mimics the working of a biological brain.

While the invention has been described with respect to a limited number of embodiments, it will be appreciated that many variations, modifications and other applications of the invention may be made. Therefore, the claimed invention as recited in the claims that follow is not limited to the embodiments described herein.

What is claimed is:

1. A non-transitory computer readable medium storing computer-executable instructions that, when executed by a processor, cause a machine learning (ML) engine to:
train a machine learning model or Artificial Intelligence (AI) of the machine learning engine using financial datasets;
receive parameter values to a Savings Plan Creator via a user interface;
generate, by the Savings Plan Creator, a savings plan for a short or a long-term savings instrument based on the provided parameter values, the savings plan creator being driven by the machine learning engine that matches the provided parameter values to an existing savings plan selected from a Plans Database having existing savings plans stored therein, or that synthesizes a customized savings plan.

2. The non-transitory computer readable medium of claim 1, wherein the savings plan is implemented by a financial manager module that creates a savings fund.

3. The non-transitory computer readable medium of claim 2, wherein the savings plan includes a disbursement schedule which is based, at least in part, on milestones, the disbursement schedule being implemented by the financial manager module by disbursing funds to beneficiaries of the savings plan.

4. The non-transitory computer readable medium of claim 3, wherein the milestones include a predetermined amount of relative wealth accrued.

5. The non-transitory computer readable medium of claim 3, wherein the milestones include a birth or a death of a beneficiary.

6. The non-transitory computer readable medium of claim 3, wherein the milestones include a predetermined number of times a value of the wealth accrued in the savings fund is doubled.

7. The non-transitory computer readable medium of claim 1, wherein the ML engine is in communication with financial institutions, and receives current financial data therefrom, and wherein the ML engine is continually trained on the current financial data.

8. The non-transitory computer readable medium of claim 1, wherein the user interface is implemented on a website or application.

9. The non-transitory computer readable medium of claim 2, wherein the savings fund is managed by the ML engine, wherein managing the savings fund includes making decisions including: where to invest, how much to invest, when to withdraw funds from investments, and combinations thereof.

10. The non-transitory computer readable medium of claim 3, wherein the disbursement schedule is managed by a virtual trustee driven by the ML engine.

11. The non-transitory computer readable medium of claim 3, wherein the milestones are met based on evidence submitted via the user interface to an Evidence Analysis Module configured to determine if the evidence is legitimate.

12. The non-transitory computer readable medium of claim 11, wherein the Evidence Analysis Module is driven by the ML engine.

13. The non-transitory computer readable medium of claim 2, wherein the long-term savings indicates that the savings fund will continue to generate wealth and effect disbursement of dividends even after a biological death of an initiator of the savings plan.

14. The non-transitory computer readable medium of claim 2, wherein the short-term savings indicates that the savings fund will generate wealth and effect disbursement of dividends at least during a lifetime of an initiator of the savings plan.

15. A computer-implemented method, comprising:
providing a non-transitory computer readable medium storing computer-executable instructions that configured to be executed by a processor;
training a machine learning model of a machine learning engine using financial datasets;
providing parameter values to a Savings Plan Creator via a user interface;
generating, by the Savings Plan Creator, a savings plan for a short or a long-term savings instrument based on the provided parameter values, the savings plan creator being driven by the machine learning engine that matches the provided parameter values to an existing savings plan selected from a Plans Database having existing savings plans stored therein, or that synthesizes a customized savings plan.

16. The computer-implemented method of claim 15, further comprising: creating a savings fund according to the savings plan.

17. The computer-implemented method of claim 16, further comprising: managing the savings plan by a financial manager module that is driven by the machine learning engine.
